(19) United States
(12) Patent Application Publication
(10) Pub. No.: US 2008/0254400 A1
(43) Pub. Date: Oct. 16, 2008

(54) Method and Tool For Oral Substrate Measurement In Animals

(75) Inventors: Dale Scott Scherl, Lawrence, KS (US); Lori Coffman, Eudora, KS (US); Rose Richter, Somerville, NJ (US); Tao Xu, Brunswick, NJ (US); Virginia Monsul Barnes, Ringoes, NJ (US)

Correspondence Address: COLGATE-PALMOLIVE COMPANY, 909 RIVER ROAD, PISCATAWAY, NJ, 08855, US

(73) Assignee: Colgate-Palmolive Company, New York, NY (US)

(21) Appl. No.: 12/090,108

(22) PCT Filed: Oct. 13, 2006
(86) PCT No.: PCT/US06/40383

§ 371 Date: Apr. 14, 2008

Related U.S. Application Data
(60) Provisional application No. 60/727,091, filed on Oct. 14, 2005.

(51) Int. Cl. A61D 5/00

(52) U.S. Cl. 433/1

(57) ABSTRACT

A gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal. A method for quantifying dental plaque in a conscious non-human animal comprising (a) aligning the tip portion of such a gingival contour probe with a gingival margin of a tooth in the animal; (b) by reference to the markings on the tip portion of the probe, measuring the length of the margin and the length of plaque deposit if any at the margin; and (c) calculating a plaque score for the tooth by comparing the length of plaque deposit with the length of the margin.

### CROSS-REFERENCE TO RELATED APPLICATIONS

This application claims priority to U.S. Provisional Application Ser. No. 60/727,091 filed Oct. 14, 2005, the disclosure of which is incorporated herein by reference.

### FIELD OF THE INVENTION

The present invention relates to methods for measuring an oral substrate such as dental plaque in non-human animals and to tools useful in such methods.

### BACKGROUND OF THE INVENTION

Issues related to oral health, more particularly periodontal disease, are some of the most common diagnoses made by small animal veterinarians in the United States. For example, in a survey diagnoses of dental calculus and gingivitis ranked as numbers 1 and 2 in prevalence for canines and felines examined at private veterinary practices. Lund et al. (1999), J. Am. Vet. Med. Assoc. 214:1336-1341.

A common etiological factor for calculus and gingivitis is bacterial plaque, which if left to accumulate and mature can encourage disease progression. See, for example, Lindhe et al. (1975), J. Periodontal Res. 10:243-255. This in turn can result in tissue destruction, loss of functionality of teeth and gums, tooth loss, and a potential for systemic infection that can endanger overall health.

Efforts to reduce formation and accumulation of plaque generate a need to accurately and reproducibly quantify plaque levels. Numerous plaque and calculus indices and techniques for their measurement have been implemented, modified and improved upon over many years, not only in human periodontology but also in veterinary dentistry. See, for example, the review by Hennet (1999), J. Vet. Dent. 16:23-29. Some early techniques proposed for use in canines quantified plaque accumulation on the entire facial crown surface of teeth. However, it is plaque more specifically on the gingival margin that is believed to have the greatest impact on development of periodontal disease, including that in non-human animals such as canines.

A plaque assessment method for use in human patients, focusing on the gingival margin, was proposed by Harrap (1974), J. Clin. Periodontol. 1:166-174. Xu & Barnes (2003), J. Clin. Dent. 14(4):93-97, proposed a “modified gingival margin plaque index” (MGMPI) for use in human patients, and also described a new curved probe useful as a tool for measuring plaque at the gingival margin, to assess MGMPI.

An example of a canine model which is generally accurate and reproducible was proposed by Logan & Boyce (1994), J. Vet. Dent. 11(2):58-63. Such models tend to be resource intensive and require specialized procedures that are generally not suitable or convenient for routine use in non-human animals, particularly where repeated measurement of plaque levels is needed over a course of treatment, or plaque measurement is to be done other than in a veterinary clinical setting, e.g., by an animal's caregiver at home. A need therefore exists for new methods for quantifying plaque at the gingival margin of a non-human animal, particularly for such methods that have reduced reliance on specialized procedures. More specifically, a need exists for such methods that reduce the necessity for sedation or anesthesia but not negatively affect animal compliance or cooperation. Such methods that at least maintain the accuracy and reproducibility of older techniques, for example the Logan-Boyce model (see Logan & Boyce (1994), supra), would be especially beneficial. A tool such as a probe adapted for use in such methods would likewise represent a useful advance in the art.

### SUMMARY OF THE INVENTION

The present invention provides a gingival contour probe comprising a shaft portion and an elongated tip portion. The tip portion is attached at a proximal end thereof to the shaft portion, and is non-planarly bent and/or curved. The tip portion carries markings, the number and scale of which are indicative of measured lengths. The probe is adapted at least by the number and/or scale of such markings for use in convenient gingival margin measurement of a tooth in a conscious non-human animal.

The present invention further provides a method for quantifying an oral substrate, e.g., dental plaque, in a conscious non-human animal. This method comprises (a) aligning the tip portion of the gingival contour probe as described above with a gingival margin of a tooth in the animal; (b) by reference to the markings on the tip portion of the probe, measuring the length of the margin and the length of oral substrate deposit if any at the margin; and (c) calculating a substrate score for the tooth by comparing the length of substrate deposit with the length of the margin.

The present invention also provides a method for conducting a study to assess effectiveness of a test regimen for reducing dental plaque accumulation in a non-human animal. This method comprises quantifying dental plaque in an animal by conducting steps (a), (b) and (c) as outlined above for each of a plurality of teeth in the animal, and calculating an average plaque score for the plurality of teeth, at a first time point before and a second time point after initiation of the test regimen, by comparison with a reference regimen.

The present invention provides a kit comprising (a) a food formulated to reduce dental plaque accumulation in a non-human animal and (b) a gingival contour probe as described above.

The present invention further provides a method of marketing a food formulated to reduce dental plaque accumulation in a non-human animal. This method comprises co-marketing or co-packaging with the food as described above.

The present invention also provides a means for communicating information relating to use of a gingival contour probe as described above by an animal's caregiver. The communicating means can illustratively comprise a label, package insert, brochure, advertisement, computer-readable digital or optical medium, audio or video presentation, website page, or a combination thereof.

### BRIEF DESCRIPTION OF THE DRAWINGS

FIG. 1 is a photograph of an illustrative gingival contour probe of the invention.

FIG. 2 presents photographically, in two enlarged views, a tip portion of an illustrative gingival contour probe of the invention.

### DETAILED DESCRIPTION OF THE INVENTION

The present invention provides a new model for quantifying plaque at the gingival margin in non-human animals that deviates from the MGMPI model proposed for use in human patients by Xu & Barnes (2003), supra, in ways that accommodate differences, for example in dentition and compliance, between human and non-human animals.

Dentition in non-human animals such as canines and felines is typically much more irregular, particularly in the topography of the gingival margin, than in humans. The term “gingival contour” herein refers to the irregularly undulating gingival margin associated with the highly non-uniform (by comparison with human dentition) sizes and shapes of teeth in a non-human animal such as a canine or feline. Thus the MGMPI probe developed for human use is not necessarily ideal for use as a gingival contour probe in a non-human animal.

Furthermore, non-human animals present a significant challenge in gaining cooperation for examination of the gingival contour. In a study involving comparison of a plurality of treatments for plaque reduction, any method that requires repeated oral prophylaxis, for example to establish a baseline before each treatment, further increases that challenge. Animal cooperation in such studies has typically been achieved through anesthesia and is highly demanding of professional resources and therefore costly.

As set forth in greater detail below, the new gingival contour probe and method of use thereof provided by the present invention addresses one or more issues encountered in translation of a human model such as MGMPI to nonhuman animals.

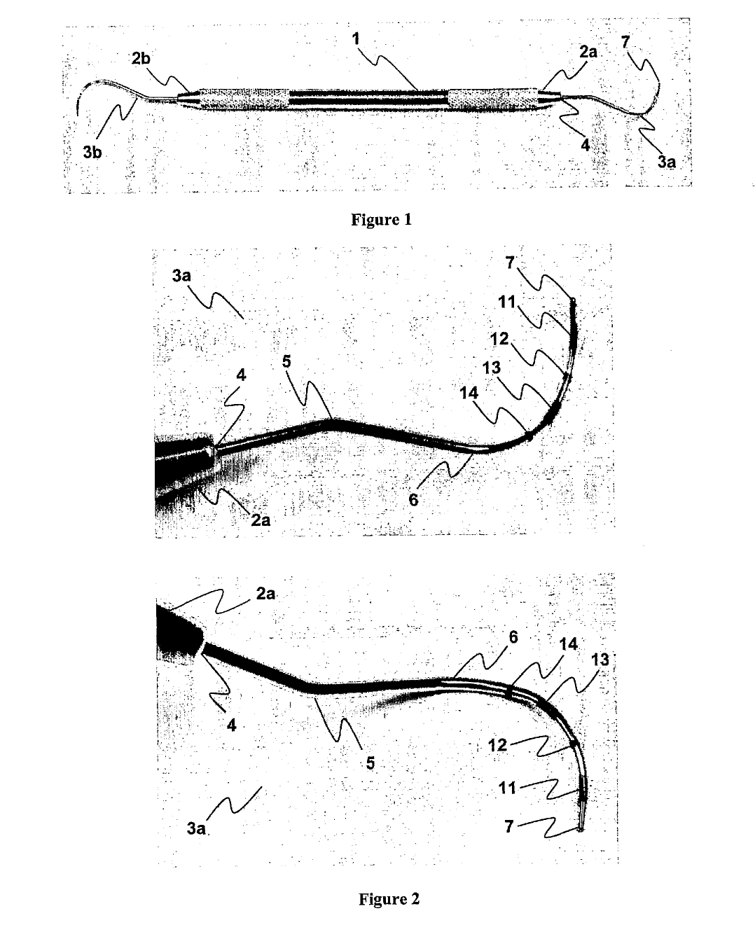

An illustrative embodiment of the gingival contour probe of the invention is shown in FIG. 1. The probe comprises a shaft portion 1 having affixed at a first end thereof an elongated tip portion 3a. In one embodiment, as illustrated in FIG. 1, a second elongated tip portion 3b is affixed at a second end of the shaft portion 1. The second tip portion 3b can have an identical, similar or contrasting configuration from tip portion 3a. It is noted, however, that the second tip portion 3b is optional herein. Tip portion 3a has a free distal end 7 and a proximal end 4 at which it is affixed to the shaft portion 1. The shaft portion optionally, as illustrated, has a tapering zone 2a adjacent to the point of attachment of the tip portion 3a and (in embodiments having a second tip portion) a second tapering zone 2b adjacent to the point of attachment of the second tip portion 3b.

Configuration of tip portion 3a is shown in greater detail for an illustrative embodiment in FIG. 2, which presents two views to enable the three-dimensional shape of the tip portion to be more clearly discerned. Importantly, the tip portion is non-planarly bent and/or curved. The term “bent” herein means undergoing a more or less abrupt change of longitudinal change of direction at one or more points along the tip portion, as illustrated, for example, by the bend at point 5 in FIG. 2. The term “curved” herein means undergoing a gradual longitudinal change of direction in one or more zones along the tip portion, as illustrated, for example, by the curve in the zone extending from point 6 in FIG. 2 substantially to the distal end 7 of the tip portion. The precise geometry of the tip portion can vary, but always is non-planar, i.e., when the instrument is laid on a planar surface, the tip portion cannot make continuous contact with the planar surface throughout its length. This is clear at least from the shadows evident in both photographs of FIG. 2, in each of which the tip portion is seen to rest on a planar surface. In the particular embodiment shown in FIG. 2, the tip portion has a bend (illustratively of about 20°) in a first plane that intersects the tapering zone 2a of the shaft portion. This bend is at a point 5 near the proximal end 4 of the tip portion. In the same particular embodiment, the tip portion has a curve (illustratively of about 180°) beginning at a point 6 distal to the bend and extending substantially to the distal end 7, at least a substantial part of the curve lying in a second plane that does not intersect the tapering zone 2a of the shaft portion.

The tip portion carries markings, the number and scale of which are indicative of measured lengths on the tip portion. Typically but not necessarily, the number and scale of the markings are indicative of curvilinear distance from the distal end. Any system of markings can be used, but in one embodiment, as illustrated in FIG. 2, the markings comprise alternating broad and narrow bands of contrasting color to the body of the tip portion. For example, a broad band 11 extends from 2 to 4 mm distant, a first narrow band 12 is located 6 mm distant, a broad band 13 extends from 8 to 10 mm distant, and a second narrow band 14 is located 12 mm distant, always from the distal end 7 of the tip portion.

The probe is adapted, at least by the number and/or scale of the markings on the tip portion, but typically also by the particular three-dimensional shape of the tip portion, for use in convenient gingival margin measurement of a tooth in a conscious non-human animal, for example by a method as described herein. The three-dimensional shape and markings of the probe illustrated in FIG. 2 have been found convenient for use in canines. Further, with or without minor modification, such a probe would also be convenient for use in felines. Selection of a suitable non-planarly bent and/or curved shape and suitable number and scale of markings can be made by one of ordinary skill in the art for any non-human animal, based on the disclosure herein. However, in a preferred embodiment, the tip portion is bent and/or curved substantially as shown in FIG. 2 and is adapted at least by the number and/or scale of the markings for use in a conscious feline or canine. In one embodiment, the probe has one set of markings on one end and a different set of markings on the other end, e.g., different scales such as a metric scale on one end and inches on the other end or different scales such as a 1 mm scale on one end and a 2 mm scale on the other end.

Markings delimiting distance increments of D mm typically permit measurement at least to a precision of 0.5×D mm, it being easy to estimate by eye a mid point between two close markings. Thus the illustrative probe of FIG. 2, with markings delimiting a plurality of 2 mm increments as measured from the distal end of the tip portion, permits measurement along a gingival contour at least to a precision of 1 mm. Such a precision has been found to be sufficient for use of the probe according to methods described herein.

The gingival contour probe of the invention is useful in many ways, for example as a diagnostic tool or as a teaching aid to demonstrate accumulation and removal of oral substrate. Primarily, however, the tool provides the basis for a new method for quantifying oral substrate accumulation.

In one embodiment, a gingival contour probe as described above is used in a method for quantifying an oral substrate in a conscious non-human animal. This method comprises (a) aligning the tip portion of the probe with a gingival margin of a tooth in the animal; (b) by reference to the markings on the tip portion, measuring the length of the margin and the length of oral substrate deposit if any at the margin; and (c) calculating a substrate score for the tooth by comparing the length of substrate deposit with the length of the margin.

Examples of types of oral substrate that can be quantified by such a method include dental plaque, calculus, stain and debris. In one series of embodiments, the substrate is plaque.

It has been found that a gingival contour probe having a tip portion that is non-planarly bent and/or curved as illustrated, for example, in FIG. 2, or that approximates to the shape, for example, of a Nabers 2N periodontal probe as used in human dentistry (but with markings as provided herein), more closely follows the curvature of the gingival margin in canine dentition than a one having essentially planar configuration, as described for use in humans according to the MGMPI model of Xu & Barnes (2003), supra. The improved alignment enables accurate and reproducible measurement with no discomfort to the animal.

Although the animal is conscious during the procedure, a drug such as atropine (e.g., about 0.02 to about 0.1 mg/kg body weight, administered subcutaneously) can be given before measurement to temporarily reduce saliva flow which could otherwise obscure or distort view of the gingival margin. Alternatively or in addition, a suitable stain, for example, a dilute (e.g., about 0.05% to about 5%) aqueous solution of methylene blue, neutral red or a fluorescein-based stain such as cosin or erythosine, can be applied to the area of the gingival margin before measurement as a disclosing agent to enhance visibility of plaque. Illustratively, aqueous eosin, about 0.5% to about 2%, has been found to work well.

Having measured the length of the gingival margin for a selected tooth and the length of plaque deposit (if any) at the margin, a plaque score for the tooth can be calculated, e.g., as a ratio or percentage of the total length of gingival margin exhibiting plaque. Preferably, the gingival margin plaque for a plurality of teeth is determined and an average plaque score is calculated, e.g., as the mean of the scores for each tooth evaluated. Scores can similarly be established for other types of oral substrate, including calculus, stain and debris.

The method can be used in any non-human animal, e.g., a non-human mammal. Illustratively among mammals, the animal can be a member of the order Carnivora, including without limitation canine and feline animals. In a particular embodiment, the animal is a companion animal. A “companion animal” herein is an individual animal of any species kept by a human caregiver as a pet, or any individual animal of a variety of species that have been widely domesticated as pets, including dogs (Canis familiaris) and cats (Felis domesticus), whether or not the individual animal is kept solely or partly for companionship. Thus “companion animals” herein include working dogs, farm cats kept for rodent control, etc., as well as pet dogs and cats.

Quantification of plaque in a human patient typically involves examination of all teeth. This is often not technically feasible in a conscious non-human animal due to lack of cooperation resulting from discomfort and/or anxiety in the animal. Illustratively in canines, however, it has been found that representative results can be obtained when measurement is limited to teeth that are accessible for such measurement without eliciting excessive anxiety or discomfort behaviors.

In canine animals, teeth that are accessible for the present purpose include maxillary 3rd incisors, canines, 1st through 4th premolars and 1st molars; and mandibular canines and 2nd through 4th premolars. Thus in one embodiment the plurality of teeth for which an average plaque score is determined for a canine are selected from the above.

Use of a method as described above can be especially advantageous in evaluating a regimen for reducing dental plaque accumulation in a non-human animal. Such a regimen can, for example, comprise one or more of dietary control, medication, provision of a chewable toy or foodstuff, oral hygiene intervention (e.g., brushing), etc. In one embodiment, the regimen evaluated is a dietary regimen, including, for example, feeding to the animal a food formulated to reduce dental plaque accumulation.

In one embodiment, a method for conducting a study to assess effectiveness of a test regimen for reducing dental plaque accumulation in a non-human animal comprises quantifying dental plaque in a animal at a first time point before and a second time point after initiation of the test regimen, by comparison with a reference regimen. Quantifying dental plaque is accomplished while the animal is conscious, by a method as described above, more particularly a method wherein gingival margin plaque is quantified in a plurality of teeth. For example, where the animal of interest is canine, the plurality of teeth for which an average plaque score is determined for a canine are selected from maxillary 3rd incisors, canines, 1st through 4th premolars and 1st molars; and mandibular canines and 2nd through 4th premolars.

A study as described above can be, but is not necessarily, a randomized experiment involving a plurality of animals. In one embodiment, the same animals are submitted to the test and reference regimens in a crossover experimental design or in a parallel experimental design. Surprisingly, it has been found that accurate and reproducible results are obtainable by this method without the need for additional oral prophylaxis, which can be expensive and time-consuming, and generally requires anesthesia, before initiation of each treatment or regimen.

The second time point (i.e., the time point after initiation of the test or reference regimen) for quantification of plaque can be at any convenient interval after initiation. However, it has been found that on day 1, plaque scores can be low and variability relatively high, and by day 4 plaque levels are beginning to saturate, resulting in loss of sensitivity. A preferred time for post-initiation plaque quantification is therefore normally about 2 to about 3 days after initiation of each regimen.

Remarkably, methods of plaque quantification according to the invention are sufficiently convenient and non-stressful to the animal that, with adaptation as appropriate, they can be used in a non-clinical setting and, in some embodiments, by a non-professional, for example the animal's caregiver. As plaque accumulation is a factor deleterious to oral health in general, and gingival health (e.g., incidence and severity of gingivitis) in particular, the present tool and method can enhance oral health by enabling monitoring of plaque accumulation in an animal subjected to a regimen for plaque reduction (e.g., a regimen comprising one or more of medication, food, chewable item, mechanical oral hygiene device, dentifrice, rinse, etc.).

Accordingly, in a further embodiment, a method for enhancing oral health of a non-human animal comprises (a) feeding to the animal a food formulated to reduce dental plaque accumulation and (b) monitoring plaque accumulation at the gingival margin of one to a plurality of teeth of the animal using a gingival contour probe as described herein, adapted at least by the number and/or scale of the markings for use in convenient gingival margin measurement of a tooth in a conscious non-human animal. Such monitoring can be done, for example, by the animal's caregiver or by a professional.

Gingivitis and other oral conditions caused in part or exacerbated by plaque accumulation are likely factors in etiology of a number of systemic disorders, including cardiovascular disease. Thus, in a still further embodiment, a method for enhancing systemic health of a non-human animal comprises (a) feeding to the animal a food formulated to reduce dental plaque accumulation, and (b) monitoring plaque accumulation at the gingival margin of one to a plurality of teeth of the animal using a gingival contour probe as described herein, adapted at least by the number and/or scale of the markings for use in convenient gingival margin measurement of a tooth in a conscious non-human animal. Again, such monitoring can be done, for example, by the animal's caregiver or by a professional.

In another embodiment, a kit is provided, for example to a caregiver, comprising material (e.g., one or more of medication, food, chewable item, mechanical oral hygiene device, dentifrice, rinse, etc.) to establish a regimen for plaque reduction, and a gingival contour probe as described herein.

Illustratively, where the regimen is at least in part a dietary regimen, such a kit comprises (a) a food formulated to reduce dental plaque accumulation in a non-human animal and (b) a gingival contour probe as described above, adapted at least by the number and/or scale of the markings on the tip portion thereof for use in convenient gingival margin measurement of a tooth in a conscious animal. The food and the probe can be packaged together or separately.

Optionally, the kit further comprises means for communicating information to the animal's caregiver. Such information can include instructions for use of the gingival contour probe in association with feeding the food to the animal, to evaluate or monitor effectiveness of the food in reducing dental plaque accumulation. The communicating means can comprise any suitable medium, including for example printed copy, video display, audio recording, computer interface, computer readable optical and digital media, the Worldwide Web, and any combination thereof. Specific examples of such communicating means include without limitation a product label, insert, brochure, handout, advertisement, public announcement, audiotape, videotape, DVD, CD-ROM, computer readable chip, card or disk, computer memory or web page. The communicating means can direct the caregiver to other sources of information, for example a telephone help line, website address, etc.

Such a communicating means, carrying information about use of a gingival contour probe as described herein, for example instructions for such use in association with feeding a food to a non-human animal to evaluate or monitor effectiveness of the food in reducing dental plaque accumulation, is itself a further embodiment of the invention.

Optionally, the kit further comprises a suitable stain, for example, methylene blue, neutral red or a fluorescein-based stain such as eosin or erythosine, typically in the form of a dilute (e.g., about 0.05% to about 5%) aqueous solution, as a disclosing agent for enhancing visibility of plaque. In one embodiment, the disclosing agent is eosin in aqueous solution at about 0.5% to about 2%. Optionally, the kit still further comprises means for applying such a disclosing agent to the gingival margin. Such means can illustratively comprise a spray bottle, a swab (optionally mounted on a stick as in Q-tips® cotton swabs), a cotton ball, a towelette, a wipe or means substantially equivalent to any of these. In one embodiment, the disclosing agent is pre-packaged in the applying means, as for example in a spray bottle containing the agent or a swab impregnated with the agent.

In another embodiment, the invention provides a method of marketing a food formulated to reduce dental plaque accumulation in a non-human animal. The method comprises co-marketing or co-packaging with the food a gingival contour probe as described above, adapted at least by the number and/or scale of the markings for use in convenient gingival margin measurement of a tooth in a conscious animal. A co-marketing program can illustratively involve one or more of the following techniques:
co-promotion of the food and the probe;
co-branding of the food and the probe, including for example a brand name or logo relating to the food printed or engraved on the shaft portion of the probe;
point-of-sale display of the probe in a retail outlet or veterinarian's office where the food is available for purchase;
coupon attached to the food packaging for purchase of the probe, e.g., at a reduced price;
rebate offer on the price of the food and/or the probe if purchased together;
free give-away of the probe on purchase of at least a minimum quantity of the food; etc.

Optionally, such a co-marketing program can optionally further comprise means for communicating information to the animal's caregiver as described above.

Such a co-marketing program can also, in some embodiments, include tie-in to professional animal grooming services that include teeth cleaning, and/or to an oral prophylaxis schedule provided by a veterinary office or clinic.

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise. Similarly, the words “comprise”, “comprises”, and “comprising” are to be interpreted inclusively rather than exclusively.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, is relevant prior art for the present invention and the right to challenge the accuracy and pertinence of such patents, patent applications, publications, and other references is specifically reserved.

### EXAMPLES

The invention can be further illustrated by the following examples, although it will be understood that these examples are included merely for purposes of illustration and are not intended to limit the scope of the invention unless otherwise specifically indicated.

### Materials and Methods

A research panel of 5, 7 or 10 mixed breed and/or Beagle dogs was used during development of a new dental plaque quantification method. Criteria for acceptance into this research panel included a moderately healthy oral cavity, and full dentition. All procedures were implemented within the strict guidelines of the Animal Care and Use Committee and the Hill's Pet Nutrition, Inc. animal welfare policy. While off-test, dogs were fed Hill's Prescription Diet® t/d® canine food, which is nutritionally complete and helps to maintain oral cleanliness. Initially, all dogs underwent oral prophylaxis according to standard procedures. Following prophylaxis, daily tooth brushing was performed when the animals were not on-test, using a commercially available power toothbrush and pet dentifrice. Prophylaxis procedures were performed approximately every 3 months to maintain optimal cleanliness and oral health.

Core study parameters were established iteratively, and resulted in a 2-cell, 8-day crossover design (4 days per cell) being used most frequently. With the exceptions noted below, the grader (the person recording plaque levels) was masked to the treatment used. Also in most of the trials, dogs were randomly assigned to either a test or a control group. All quantification procedures were performed on conscious animals, however atropine (0.06 mg/kg body weight, subcutaneous) was used only to temporarily reduce saliva flow. Feeding and plaque scoring were each conducted at consistent times of day during the study period.

On day 0 (baseline), the dog's teeth were thoroughly brushed, and the lengths of the gingival margins of selected teeth were measured to a precision of 1 mm using the gingival contour probe shown in FIGS. 1 and 2. Also at baseline, lengths of any plaque along these margins remaining after brushing were measured with the aid of a dilute solution of eosin. Following baseline measurements, dogs were fed a first food (test or control) for periods of 2 to 7 days. On the final day of the first leg of each study, dogs were again assessed for gingival margin plaque accumulation. The following day, dogs had their teeth brushed, had new baseline plaque scores recorded, and were then crossed over to the second food. After the assigned period on the second food, the plaque along the gingival margin was again measured and recorded.

Plaque scores were calculated for each tooth as a percent of the length of the gingival margin.

Individual tooth score=(length of plaque along margin)/(margin length)×100 (1)

The individual tooth scores were then averaged to obtain a whole mouth score.

Whole mouth score=(sum of individual tooth scores)/(number of teeth scored) (2)

The whole mouth score was used to calculate a numerical plaque increase from baseline on each of the selected grading days.

Plaque increase=(whole mouth score: day n)−(whole mouth score: baseline) (3)

Finally, the efficacy difference between the test and control food was calculated as a percentage of the plaque increase from baseline for the control food.

Efficacy difference=(plaque increase: control−plaque increase: test)/(plaque increase: control)×100 (4)

Differences were tested for statistical significance (p<0.05) using a paired student t-test. The maxillary teeth included in these studies were the 3rd incisors, canines, 1st through 4th premolars, and 1st molars. The mandibular teeth included were the canines and 2nd through 4th premolars.

### Results

The following experiments were run as a means of validating the new dental plaque quantification method.

Margin Measurements. Gingival margin lengths were measured several times over a period of 75 days to determine measurement consistency and drift. The results showed that over this time period, there was no significant deviation in measured margin lengths. Average differences from the initial measurements ranged from −3.1% to +4.3%, and none were statistically significant. From the results of this experiment, it was determined that if the same panel of dogs are to be included as study subjects on a ongoing basis, the margin lengths needed to be measured no more frequently than 4 times per year, and were therefore recorded opportunistically at the time of each maintenance prophylaxis.

Time Course. The optimal period of time to allow plaque to accumulate along the gingival margin was assessed in three separate experiments. At issue was the effect the degree of plaque saturation (defined as plaque growth along the gingival margin that is approaching or has reached 100% coverage) would have on sensitivity of this method. While a large plaque increase was desirable to be able to quantify a broad range of plaque-reducing technologies, it was theorized that saturation of plaque along the margin would attenuate differences between them.

In a first experiment, plaque scores were recorded at baseline and again 1, 2, 3 and 4 days later to document marginal plaque accumulation rates while the dogs were being fed a control diet. The results demonstrated that plaque increases at days 1, 2 and 3 were within a substantially linear portion of the plaque growth curve, and were therefore potentially acceptable for data collection.

A second experiment was run to assess effect of the data collection time point on the calculated plaque-reducing efficacy differences between two foods. Specifically, plaque saturation along the gingival margin was explored as a source of error. Hill's Prescription Diet® t/d® (test food) and a complete maintenance food (control food) were used for this non-blinded crossover study in which plaque measurements were made 1, 2, 3 and 7 days after baseline. The results showed that the rate of plaque growth along the gingival margin was clearly slower when the dogs were fed the test food, however the calculated superiority of this diet was affected once the gingival margins of dogs on the control food began to saturate with plaque. Until this point, a daily calculated difference between foods was similar, giving values of 55%, 66% and 60% for days 1, 2 and 3 respectively, but fell to 35% on day 7 when the margins for the control food had begun to saturate but those for the test food had not. In addition, there was a high degree of variability in the scores for day 1 (most likely caused by the low plaque scores for that day) and therefore days 2 and 3 were deemed most reliable.

A third experiment was run to determine whether results of a 5-day cross-over trial (scoring plaque after periods of 2 days on each assigned food) provided the same results statistically as an 8-day trial. The same test and control foods as in the previous study were used for this blinded study, which resulted in a plaque-reducing efficacy of the test food of 51±16%. There was no statistical difference between this result and the average result for the same foods tested in an 8-day study design (below). Thus, there appears to be a window of opportunity within which all scoring should ideally be done. It is likely that when plaque scores are low (day 1), variability is high and the results can be questionable. It is also likely that when the margins begin to saturate (day 4), sensitivity of the study could be negatively affected. Therefore best practice appears to be to perform assessments on days 2 or 3.

Study-To-Study Variability. Five separate 5-dog, 8-day blinded studies were run comparing Prescription Diet® t/d® (test) to a complete maintenance food (control) for consistency and reproducibility of the plaque-reducing efficacy data. The results of these experiments showed that the normalized variability (coefficient of variation) of the method was less than 18%, with an average difference between test and control of 46±8%.

Feeding Order. Experiments were run to assess effect on plaque-reducing efficacy data of order of feeding Prescription Diet® t/d® (test) and a complete maintenance food (control) in a non-blinded study. When the test food was fed first, the average difference between treatments was 40±11% (p=0.0149). When the control food was fed first, the average difference between treatments was 38±15% (p=0.0014). Thus, the results are independent of feeding order.

Panel-To-Panel Variation. Studies were conducted to determine effect of using different panels of animals on plaque reducing efficacy data. Studies comparing Prescription Diet® t/d® (test) to a complete maintenance food (control) were run using two different panels of 5 dogs, and the results were compared. The first panel, consisting of 2 mixed-breed dogs and 3 Beagle dogs, resulted in a 40±11% difference between foods (p=0.0149). The second panel, consisting of 5 Beagle dogs, resulted in a 49±9% difference between foods (p=0.0004). A statistical comparison between the groups indicated no significant difference between panels.

Intra-Grader Variation. A study was run to assess intra-grader variation, by having a single grader score plaque from each dog in random order. The foods used for this experiment were Prescription Diet® t/d® (test) and a complete maintenance food (control), assigned randomly and blinded to the grader. Absolute differences between the first and second grading were between 3% and 12%, with an average difference of about 6% over 4 grading sessions. A statistical analysis of the data indicated no significant difference between the first and second grading (p>0.05).

Inter-Grader Variation. A study was run to assess inter-grader variation, by having 2 different graders score plaque accumulation from each dog in random order on different days. Test and control foods used for this study were the same as those used in the intra-grader variation study, and were blinded to the graders. Data from scoring sessions each day were used to compare the scores achieved by each grader, and then these individual scores were combined to calculate the average differences between graders. Variation between graders was monitored by comparing (1) each grader's whole mouth plaque scores and (2) each grader's calculated efficacy difference values. The resultant inter-grader variability for whole mouth plaque scores averaged 18.0%, while the variability in efficacy difference averaged 10.4%. Neither of these measures gave a statistically significant difference between graders (p=0.2920 and 0.3586 respectively). Although these data suggest that results of the present method are independent of grader identity, it is still recommended that a single grader be used to score plaque throughout each study.

Differential Efficacy and Correlation to Traditional Methods. Studies were run that allowed assessment of ability of the present method (1) to distinguish between foods of varying degrees of efficacy, including foods with a known “stair-step” profile relative to one another, and (2) to correlate with the findings of traditional plaque quantification methods. Data collected from studies comparing:

Prescription Diet® t/d® vs. a complete maintenance food;

Science Diet® Oral Care® vs. a complete maintenance food; and

a modestly efficacious reference food vs. a complete maintenance food;

were used to document method sensitivity to differential efficacies, and correlations to traditional methods.

The Prescription Diet® t/d® studies using the present method resulted in an average 46±8% efficacy difference over the control. The Science Diet® Oral Caret® studies resulted in an efficacy difference of 33.0±2.3% over the control. In a 2-tailed t-test, efficacy of Science Diet® Oral Care® was significantly different (p=0.0034) from that of Prescription Diet® t/d®, indicating that the present method can distinguish between differentially efficacious technologies.

To compare these results to those achieved by more traditional methods, published historical information was used. In a previous test of Science Diet® Oral Care® vs. a control food using the Logan-Boyce plaque assessment method (Logan & Boyce (1994), supra), Science Diet® Oral Care® was shown to be 28% superior to the control (file data), and therefore in close agreement with the 33% difference described for the present method.

More recently, Logan et al. (2002), J. Vet. Dent. 19:15-18, documented a 39% plaque accumulation difference between dogs fed Prescription Diet® t/d® and those on a control food in a 6-month plaque and gingivitis study, which further exemplifies the high degree of correlation between the present method and the Logan-Boyce method.

In a direct correlation study to evaluate a modestly efficacious reference food (test) vs. a grocery store brand food (control) using the present method and the Logan-Boyce method, 10 dogs (5 per cell, blocked on calculus and plaque) were selected for participation from a group of 30 that were taking part in a traditional Logan-Boyce study. Data for the present method were generated and evaluated as two 5 dogs/cell parallel studies (one during the first leg and another during the second leg of the traditional assessment), in addition to a crossover design (using data from both legs) to explore any potential differences between methods. Dogs were randomly assigned to either the test or control food. Results from the Logan-Boyce method revealed modest plaque attenuation efficacy from the test food of about 13.5%. Using data from the present method, the test food gave a 10.3%, 10.4% and 9.9% reduction in plaque accumulation, for the first leg parallel comparison, the second leg parallel comparison, and the full study crossover comparison respectively. Taken together, these studies indicate a high degree of correlation between the present method and the traditional Logan-Boyce model for assessment of modestly efficacious technologies, highly efficacious technologies, and when comparing data generated at long time points, with a correlation coefficient of 0.9714.

### Discussion

The probe and method of the present invention allows accurate and reproducible quantification of gingival margin plaque reduction efficacy, concomitant with a substantial reduction in human and animal resource requirements. Adaptation of this method for use in animals has involved substantial modifications to the method described by Xu & Barnes (2003), supra, for human use. Such modifications have included the probe used for measurement, the time allowed for plaque growth, elimination of the study-related prophylaxis. The present method has been validated based on parameters that could affect accuracy and reproducibility. A distillation of the data from all studies run during the validation process suggests that a crossover design using 2 or 3 days for plaque accumulation produces consistent results with known variability. For example, the data from crossover studies using 5 dogs reveals a coefficient of variation of approximately 18%, which allows consistent detection of differences between treatments of ≧35% of the mean. These data also allow power predictions for increased animal numbers, which have suggested that use of 10 dogs would permit consistent detection of differences between treatments of ≧22% of the mean. Therefore, studies requiring increased sensitivity can be accomplished by increasing the number of subjects by only a few animals. Clearly, this validation process has shown the present method to be accurate, reproducible and well correlated to conventional methods.

The present method has been shown to be well correlated to a study that evaluated the plaque and gingivitis reducing efficacy of Prescription Diet® t/d® during a 6-month clinical study using the traditional Logan-Boyce method (Logan et al. (2002), supra). In addition to plaque scores, the traditional study documented that, at the plaque attenuation levels seen, there was also a substantial (36%) reduction in gingivitis vs. the control, which suggests a direct relationship between plaque reduction and gingival health.

Recently, concerns have been raised about some conventional scoring methods that allow equal weighting of the gingival and coronal halves of teeth, and the clinical relevance of such methods have been questioned. However, the method of the present invention evaluates plaque accumulation only at the gingival margin where clinical relevance is well documented.

Additionally, concerns over variability in shape and size of the teeth being scored, leading to the possibility of inappropriately weighting the scores, using conventional scoring methods have been raised. To address such concerns, the present method can be adapted to accommodate differences in tooth size. More specifically, whole mouth plaque scores can be calculated using the sum of the plaque lengths along the gingival margin, divided by the sum of the gingival margin lengths for each dog. Longer margins, associate with larger teeth, would therefore contribute more to the total margin length than smaller margins. This “total margin” method may provide a truer representation of the total bacterial insult to the gingival margin. Results using this “total margin” method have been directly compared to the results reported above. No significant difference in the outcome of any of the validation experiments described herein has been seen. In addition, most of the plaque scores generated using each of these methods were within a few percentage points of one another, and all were well within experimental error.

### Conclusions

The method of the present invention has been shown to be a quick, accurate, reproducible, and less resource-intensive method of quantifying plaque and evaluating efficacy of plaque-reducing technologies in non-human animals, in this case canines. The skills required to use the probe and perform the method are quickly and easily learned, and therefore the present method is well suited to implementation in field trials. Finally, given the ease of implementation, the concepts underlying the present method can be extended to calculus evaluations and can be extended to mammals other than canines.

In the specification, there have been disclosed typical preferred embodiments of the invention and, although specific terms are employed, they are used in a generic and descriptive sense only and not for purposes of limitation, the scope of the invention being set forth in the claims. Obviously many modifications and variations of the invention are possible in light of the above teachings. It is therefore to be understood that within the scope of the appended claims the invention may be practiced otherwise than as specifically described

What is claimed is:

1. A gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal.

2. The probe of claim 1 adapted at least by the number and/or scale of the markings for use in a conscious canine or feline animal.

3. The probe of claim 2 wherein the tip portion is bent and/or curved substantially as shown in FIG. 2.

4. The probe of claim 2 wherein the number and scale of the markings permit measurement to a precision of about 0.5 mm.

5. The probe of claim 4 wherein the markings delimit a plurality of 1 mm segments as measured from a distal end of the tip portion.

6. The probe of claim 5 wherein the markings comprise broad bands occupying a zone from 2 mm to 4 mm and a zone from 8 mm to 10 mm from the distal end, and narrow bands at 6 mm and 12 mm from the distal end.

7. A method for quantifying oral substrate accumulation in a conscious non-human animal comprising (a) aligning the tip portion of the gingival contour probe of claim 1 with a gingival margin of a tooth in the animal; (b) by reference to the markings on the tip portion of the probe, measuring the length of the margin and the length of substrate deposit if any at the margin; and (c) calculating a substrate score for the tooth by comparing the length of substrate deposit with the length of the margin.

8. The method of claim 7 wherein the substrate is plaque.

9. The method of claim 8 comprising conducting steps (a), (b) and (c) for each of a plurality of teeth in the animal, and calculating an average plaque score for the plurality of teeth.

10. The method of claim 9 wherein the animal is feline.

11. The method of claim 9 wherein the animal is canine.

12. A method for conducting a study to assess effectiveness of a test regimen for reducing oral substrate accumulation in a non-human animal comprising quantifying oral substrate in an animal by the method of claim 8 at a first time point before and a second time point after initiation of the test regimen, by comparison with a reference regimen.

13. The method of claim 12 wherein the substrate is plaque.

14. The method of claim 13 wherein the same animals are submitted to the test and reference regimens in a crossover experimental design or in a parallel experimental design.

15. The method of claim 13 wherein the second assessment time is about 2 to about 3 days after initiation of each regimen.

16. The method of claim 13 wherein the test regimen is a dietary regimen.

17. A method for enhancing oral health of a non-human animal comprising (a) feeding to the animal a food formulated to reduce dental plaque accumulation and (b) monitoring plaque accumulation at the gingival margin of one to a plurality of teeth of the animal using a gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal.

18. A method for enhancing systemic health of a non-human animal comprising (a) feeding to the animal a food formulated to reduce dental plaque accumulation and (b) monitoring plaque accumulation at the gingival margin of one to a plurality of teeth of the animal using a gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal.

19. A kit comprising (a) a food formulated to reduce dental plaque accumulation in a non-human animal and (b) a gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal.

20. The kit of claim 19 further comprising means for communicating information to the animal's caregiver, the information including instructions for use of the gingival contour probe in association with feeding the food to the animal, to evaluate or monitor effectiveness of the food in reducing dental plaque accumulation.

21. The kit of claim 19 further comprising a disclosing agent for enhancing visibility of plaque.

22. A method of marketing a food formulated to reduce dental plaque accumulation in a non-human animal comprising co-marketing or co-packaging with the food a gingival contour probe comprising a shaft portion and an elongated tip portion attached at a proximal end thereof to the shaft portion, the tip portion being non-planarly bent and/or curved and carrying markings, the number and scale of which are indicative of measured lengths; the probe being adapted at least by the number and/or scale of the markings for use in convenient gingival margin measurement of a tooth in a conscious non-human animal.

23. The method of claim 22 wherein the co-marketing or co-packaging includes means for communicating information to the animal's caregiver, the information including instructions for use of the gingival contour probe in association with feeding the food to the animal, to evaluate or monitor effectiveness of the food in reducing dental plaque accumulation.

24. A means for communicating information relating to use of the gingival contour probe of claim 1 by an animal's caregiver, the means being selected from the group consisting of product labels, inserts, brochures, handouts, advertisements, public announcements, audiotapes, videotapes, DVDs, CD-ROMs, computer readable chips, cards and disks, computer memory, web pages, and combinations thereof.
